(19) United States
(12) Patent Application Publication
(10) Pub. No.: US 2005/0089638 A1
(43) Pub. Date: Apr. 28, 2005

(54) Nano-material thermal and electrical contact system

(75) Inventor: Nasreen G. Chopra, Belmont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Koila, Inc., Sunnyvale, CA (US)

(21) Appl. No.: 10/943,803

(22) Filed: Sep. 16, 2004

Related U.S. Application Data
(60) Provisional application No. 60/503,638, filed on Sep. 16, 2003.
(60) Provisional application No. 60/503,613, filed on Sep. 16, 2003.

(51) Int. Cl. B05D 1/40; B05D 3/00

(52) U.S. Cl. 427/331

(57) ABSTRACT

A method for enhancing contact between a nanotube and a first material comprises providing a nanotube, said nanotube having ends and treating at least one of said ends of said nanotube. In one embodiment, the contact is thermal contact. In another embodiment, the treating step includes exposing said nanotube to an oxygen plasma or energetic oxygen. In a specific embodiment, the treating step includes opening at least one of said ends of said nanotube. Additionally, the invention provides a nano-engineered material that includes a base material, a nanostructure coupled to said base material, wherein said nanostructure is treated to enhance thermal contact, and a contact-enhancing material coupled to said nanostructure. In a specific embodiment, the treatment of said nanostructure includes exposing said nanostructure to an oxygen plasma or energetic oxygen.

### CROSS-REFERENCES TO RELATED APPLICATIONS

This application claims the benefit of the following provisional U.S. patent applications:
Application No. 60/503,638, filed Sep. 16, 2003, entitled “System for Developing Production Nano-Material”; and
Application No. 60/503,613, filed Sep. 16, 2003, entitled “Nano-Material Thermal and Electrical Contact System.”

This application incorporates by reference for all purposes the entire disclosures of the following seven provisional U.S. patent applications:
Application No. 60/503,591, filed Sep. 16, 2003, entitled “Nano-Material for System Thermal Management”;
Application No. 60/503,612, filed Sep. 16, 2003, entitled “Oriented Nano-Material for System Thermal Management”;
Application No. 60/503,638, filed Sep. 16, 2003, entitled “System for Developing Production Nano-Material”;
Application No. 60/503,613, filed Sep. 16, 2003, entitled “Nano-Material Thermal and Electrical Contact System”;
Application No. 60/532,244, filed Dec. 23, 2003, entitled “Nanotube Augmentation of Heat Exchange Structure”;
Application No. 60/544,709, filed Feb. 13, 2004, entitled “Nano-Material Thermal Management System”; and
Application No. 60/560,180, filed Apr. 6, 2004, entitled “Heat Transfer Structure.”

The following five regular U.S. patent applications (including this one) are being filed concurrently, and the entire disclosures of the other four are incorporated by reference into this application for all purposes.
Application Ser. No. ______, filed Sep. 16, 2004, entitled “Nano-Composite Materials for Thermal Management Applications” (Attorney Docket No. 022353-000110US);
Application Ser. No. ______, filed Sep. 16, 2004, entitled “Nanostructure Augmentation of Surfaces for Enhanced Thermal Transfer with Increased Surface Area” (Attorney Docket No. 022353-000210US);
Application Ser. No. ______, filed Sep. 16, 2004, entitled “Nanostructure Augmentation of Surfaces for Enhanced Thermal Transfer with Improved Contact” (Attorney Docket No. 022353-000220US);
Application Ser. No. ______, filed Sep. 16, 2004, entitled “System for Developing Production Nano-Material” (Attorney Docket No. 022353-000310US); and
Application Ser. No. ______, filed Sep. 16, 2004, entitled “Nano-Material Thermal and Electrical Contact System” (Attorney Docket No. 022353-000410US).

### BACKGROUND OF THE INVENTION

The present invention relates in general to thermal management, and in particular to thermal and electrical contact structures and methods for nano-engineered materials.

Electronic devices such as microprocessors generate heat as they operate, and excessive heat can lead to device failure. Heat sinks are frequently employed to transfer heat away from the device into the surrounding environment, thereby maintaining the device temperature within operational limits. A typical heat sink is constructed of copper or another metal with high thermal conductivity and has one flat surface for contacting the heat source (e.g., the top surface of the device package) and an opposing surface that includes fins or similar features to increase the surface area exposed to the environment. A thermally conductive adhesive is often used to bond the heat sink to the device package for improved heat transfer into the heat sink. Heat sinks can be further supplemented with fans that keep air flowing across the exposed surface area while the device is operating.

This conventional thermal management technology, which has been effective for many years, has its limitations. As the number and density of heat-generating elements (e.g., transistors) packed into devices has increased, the problem of heat dissipation has become a critical consideration in device and system design. It would therefore be desirable to provide improved thermal management technologies suitable for use with electronic devices.

### SUMMARY OF THE INVENTION

The present invention relates in general to thermal management, and in particular to thermal and electrical contact structures and methods for nano-engineered materials. Embodiments of the present invention provide structures and methods for improving the thermal and/or electrical contact between nano-engineered materials and other materials with which the nano-engineered materials are coupled.

According to one aspect of the present invention, a method for enhancing contact between a nanotube and a first material is provided. The method includes providing a nanotube with ends and treating at least one of the ends of the nanotube. In one embodiment, the contact is thermal contact. In another embodiment, the contact is electrical contact. In a particular embodiment, the treating step includes exposing the nanotube to an oxygen plasma and/or energetic oxygen. In a specific embodiment, the treating step includes opening at least one of the ends of the nanotube.

According to another aspect of the present invention, a nano-engineered material includes a base material and a nanostructure coupled to the base material, wherein the nanostructure is treated to enhance thermal contact. The nano-engineered material also includes a contact-enhancing material coupled to the nanostructure. In a particular embodiment, the treatment of the nanostructure includes exposing the nanostructure to an oxygen plasma and/or energetic oxygen. In a specific embodiment, the treatment of the nanostructure includes opening a portion of the nanostructure.

According to yet another aspect of the present invention, a nano-composite material includes a matrix material and a nanostructure incorporated into said matrix material, wherein said nanostructure is treated to enhance thermal contact.

A wide variety of thermal transfer devices may incorporate aspects of the present invention. Examples include heat sinks for electronic, optical or mechanical devices; device packaging; printed circuit boards; and semiconductor device layers.

The following detailed description together with the accompanying drawings will provide a better understanding of the nature and advantages of the present invention.

### BRIEF DESCRIPTION OF THE DRAWINGS

FIG. 1A illustrates a laminate nano-composite material according to an embodiment of the present invention;

FIG. 1B illustrates a nano-composite material according to another embodiment of the present invention;

FIG. 2 is a flow diagram of a process for treating nanotubes to enhance thermal properties according to an embodiment of the present invention;

FIG. 3 is a flow diagram of an alternative process for treating nanotubes to enhance thermal properties according to an embodiment of the present invention;

FIGS. 4A-4C are simplified cross-sectional schematic views of the fabrication of a laminate structure according to an embodiment of the present invention;

FIG. 5 is a schematic diagram of a thermal dissipation measurement system according to an embodiment of the present invention; and

FIG. 6 is a flow diagram of a process for treating nanotubes to enhance electrical conductivity according to an embodiment of the present invention.

### DESCRIPTION OF SPECIFIC EMBODIMENTS

The present invention relates in general to thermal management, and in particular to thermal and electrical contact structures and methods for nano-engineered materials. Embodiments of the present invention provide structures and methods for improving the thermal and/or electrical contact between nano-engineered materials and other materials with which the nano-engineered materials are coupled.

The term “nanostructure,” or nanoscale structure is used herein to refer to a structure with at least one dimension that is on the order of nanometers (e.g., from about 1 to 100 nm); one or more of the other dimensions may be larger and may be microscopic (from about 10 nm to a few hundred micrometers) or macroscopic (larger than a few hundred micrometers). Specific embodiments use nanotubes (e.g., carbon or boron nitride nanotubes). However, other embodiments can use nanostructures such as nanorods, nanofibers, nanocrystals, fullerenes, and other nanoscale structures such as diamond dust made from crystalline or CVD diamond flecks, as well as chains of nanocrystals or fullerenes.

The term “nano-engineered material” is used herein to refer a material that includes (or possibly consists essentially of) nanostructures. Nano-engineered materials include, for example, mats of nanostructures, groupings of nanostructures deposited on a patterned layer using deposition techniques, and nano-composite materials.

The term “nano-composite material” is used herein to refer to a composite material comprising a base, or matrix, material into which are incorporated nanostructures. In some embodiments, the nanostructures are dispersed into the base material. In other embodiments, the nano-composite material has a layered structure in which some layers are made of a base material while other layers are made entirely or predominantly of nanostructures. Nano-composite materials may incorporate one or more different kinds of nanostructures, with the nanostructures being selected for high thermal conductivity or other desirable thermal properties in some applications. Additional details regarding nano-composite materials are found in the above-referenced co-pending application Ser. No. ______,(Attorney Docket No. 022353-000110US).

For thermal management applications, nanostructures having higher thermal conductivity than the base material are advantageously used to enhance the thermal conductivity of the base material so that the resulting nano-composite material has higher thermal conductivity than the base material. In preferred embodiments, the nanostructures include nanotubes having very high thermal conductivity. Nanotubes are best described as long, thin cylindrically shaped, discrete fibril structures whose diameters are on the order of nanometers. Nanotubes can exhibit lengths up to several hundred microns; thus their aspect ratios can exceed 1000. The aspect ratio can be well controlled using process conditions as is known in the art. The terms “single-wall” or “multi-wall” as used to describe nanotubes refer to nanotube structures having one or more layers of continuously ordered atoms where each layer is substantially concentric with the cylindrical axis of the structure; the nanotubes referred to herein may include single-walled and/or multi-walled nanotubes.

Nanotubes have theoretically and experimentally been shown to have high thermal conductivity along the axis of the nanotube. The thermal conductivity of carbon nanotubes, for example, has been measured at around 3000 W/m*K (theoretical calculations indicating conductivities as high as 6000 W/m*K might be achievable), as compared to conventional thermal management materials such as aluminum (247 W/m*K) or copper (398 W/m*K).

Nanotubes for a nano-composite material may be made of a variety of materials including carbon. In one embodiment, boron nitride (BN) nanotubes are used. The electrical properties of BN nanotubes are particularly well suited to applications where a heat transfer device is required to provide electrical isolation as well as thermal conduction because all chiralities of BN nanotubes are semiconductors with a very large bandgap that can act as electrical insulators in many applications. It will be appreciated that other materials may also be substituted.

Nanotubes can be synthesized in various ways including arc-discharge, laser ablation, or chemical vapor deposition (CVD) processes and the like. Particular synthesis techniques are not critical to the present invention. As is known in the art, many of these techniques involve depositing a catalyst material onto a substrate and growing a cluster or bundle of nanotubes where catalyst material is present. Thus, while the present description refers to nanotubes, it is to be understood that clusters or bundles of nanotubes may be used to realize aspects of the invention.

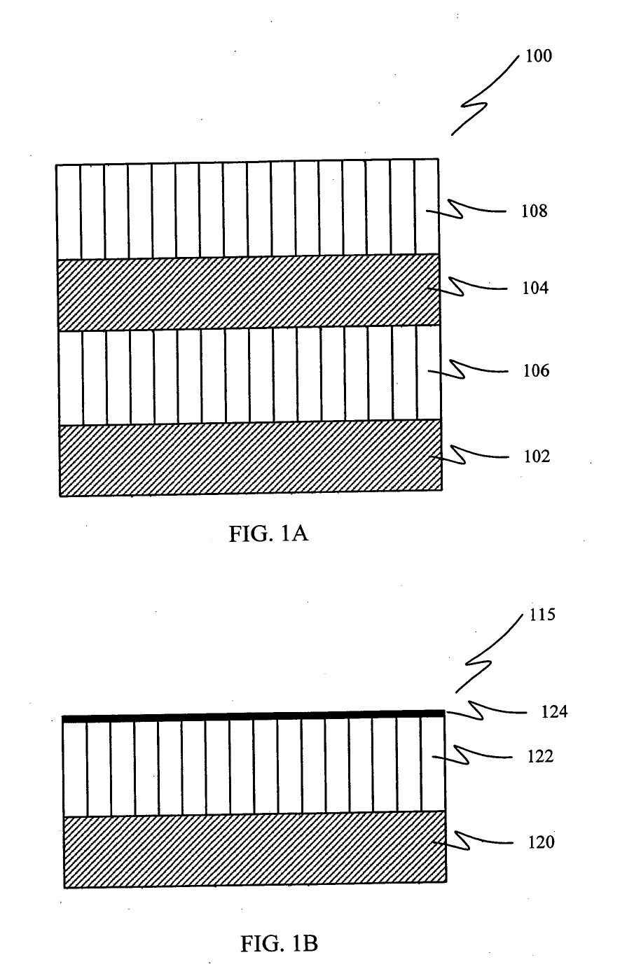

As described more fully in the above-referenced co-pending application Ser. No. ______(Attorney Docket No. 022353-000110US), laminate nano-composite materials can be formed by depositing (or growing) alternating layers of matrix material and nanotubes. FIG. 1A illustrates a laminate nano-composite material 100 in which layers 102, 104 of a matrix, or base, material are separated by film-like layers 106, 108 comprising aligned (or generally aligned) nanotubes. The matrix material may be a metal (e.g., copper), a polymer (e.g., polyimide), or other material, and different layers may be made up of different base materials or different combinations of base materials. Nanotubes may be made of any suitable elements, e.g., carbon or boron nitride. In some embodiments, the interiors of some or all of the nanotubes may be wholly or partially filled with the matrix material; in other embodiments, the interiors of the nanotubes may be empty. Laminate nano-composite materials may comprise any number of layers and, in some embodiments, have a macroscopic total thickness. The top and bottom surface layers may each be made of matrix material or nanotube films as desired.

Nano-composite material 100 can be formed, e.g., by depositing a layer of a matrix material with a desired thickness on a substrate (not explicitly shown in FIG. 1A), growing nanotubes on the base material, then depositing a new layer of matrix material on top of the nanotubes and repeating the process until the desired total thickness of the material is reached. Alternatively, nanotube films can be grown on a layer of matrix material; the resulting composite may be cut into sections that are then stacked to produce material 100.

One factor that will impact the thermal conductivity of the laminate structure is the thermal contact resistance between adjacent layers. At the interface between the matrix material 102 and the nanotubes in film layer 106, the thermal contact resistance will be reduced because the nanotubes are grown directly on the surface of the matrix material. The same result will be present at the interface between the matrix material 104 and the nanotubes in film layer 108. This is not necessarily the case at interface 106/104.

The relative proportions of matrix material and nanotubes making up the laminate nano-composite material can be varied, for instance by varying the relative thicknesses of nanotube films 106, 108 and matrix material layers 102, 104. In one embodiment, the nanotubes are around 100 μm long, while the matrix material sheets are about 50-100 angstroms (Å) (i.e., 5-10 nm) thick. In some embodiments, the matrix material is flexible or malleable, and the resulting nano-composite material may also be flexible or malleable.

Although the embodiment of the present invention shown in FIG. 1A illustrates a laminate nano-composite material, this is not required by the present invention. Other nano-engineered materials will also benefit by the method and system of the present invention. For example, nano-composite materials in which the nanotubes are randomly oriented and uniformly mixed into a matrix of amorphous material to form a nano-composite material are within the scope of the present invention. Moreover, nano-composite materials in which the nanotubes have an aligned orientation in the bulk material matrix (i.e., the axes of the nanotubes are approximately parallel) are within the scope of the present invention. These and other nano-composite materials that benefit from the present invention are described more fully in above-referenced co-pending U.S. patent application Ser. No. ______ (Attorney Docket No. 022353-000110US).

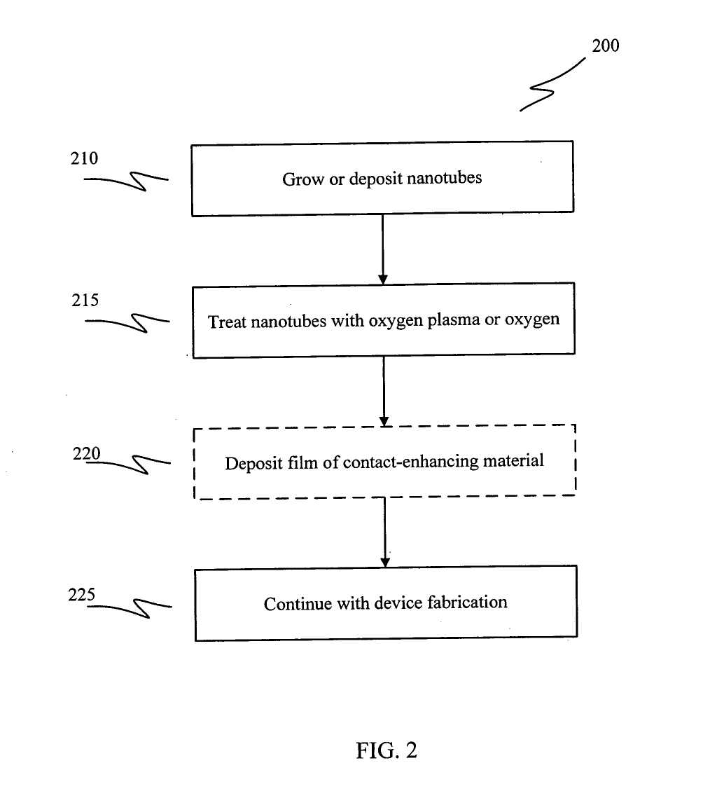

In some embodiments, the “free” ends of the nanotubes are advantageously treated prior to depositing the next layer of base material in order to improve thermal contact between the layers. FIG. 2 is a flow diagram of a process 200 for treating nanotubes to enhance thermal conductivity at the interface that can be employed during formation of laminate or other nano-composite materials.

At step 210, nanotubes are grown (e.g., using CVD or other conventional processes) or deposited onto a substrate or base material. After nanotube growth or deposition, a “treating” step 215 is performed to open the ends of the nanotubes and reduce variations in the lengths of the nanotubes. In one embodiment, step 215 includes exposing the nanotubes to an oxygen plasma or energetic oxygen at a suitable temperature (e.g., 700° C.) so that carbon near the tips is converted to CO and/or CO₂. Although some embodiments utilize a treating step in which the ends of the nanotubes are opened as carbon near the tip is converted to CO and/or CO₂, this is not required by the present invention. Alternative embodiments expose the nanotubes to an oxygen plasma or energetic oxygen in an environment in which residual carbon atoms not bonded in the nanotube lattice are removed while the ends of the nanotubes remain closed.

Once the nanotubes have been treated, a film of contact-enhancing material is optionally deposited (step 220) over the ends of the nanotubes in substantially uniform. thermal contact with the nanotubes. The contact-enhancing material is advantageously selected for high thermal conductivity; for example, copper, silver, aluminum, indium, or other metals are used in specific embodiments. In some embodiments, the contact-enhancing material is deposited in situ so that the tip of the opened or closed nanotube is not exposed to an ambient environment. In a particular embodiment, nanotubes with open ends are filled with the contact-enhancing material, although this is not required by the present invention. Filling of the nanotubes with the contact-enhancing material can increase the thermal contact between the nanotubes and the film of contact-enhancing material, thereby increasing the thermal conductivity of the structure.

FIG. 1B illustrates a nano-composite material 115 after step 220 has been performed. Nanotubes 122 are shown as deposited or grown on base 120. After step 215 is performed, contact-enhancing material 124 is deposited over the ends of the nanotubes in substantially uniform thermal contact with the nanotubes.

At step 225, device fabrication continues as appropriate. In some embodiments, the film deposited at step 220 is used as the next base material layer for a laminate structure as illustrated in FIG. 1A. In these embodiments, the next steps generally involve depositing or growing another film of nanotubes. In other embodiments, further deposition of base material may be performed prior to further nanotube growth. As discussed above, these subsequent deposition processes are in situ processes in some embodiments according to the present invention.

Although the foregoing discussion relates to treatment of nanotubes in a laminate structure, this is not required by the present invention. “Treating” of portions of the nanotubes other than the ends of the nanotubes is performed in alternative embodiments. For example, nano-composite materials in which the nanotubes are randomly oriented and uniformly mixed into a matrix of amorphous material can be treated on an upper surface, opening the portions of the nanotubes lying in the plane of the upper surface. As a result, in a particular embodiment, ends or sides of the nanotubes lying in the plane of the upper surface come in contact with the oxygen plasma or energetic oxygen so that carbon lying in and near the upper surface is converted to CO and/or CO₂. Subsequent deposition of a film of contact-enhancing material is performed as discussed in relation to the laminate structures. As discussed previously, deposition of contact-enhancing material can result in filling of the nanotubes with contact-enhancing material. In some embodiments, the contact-enhancing material filling the nanotubes and the film of contact-enhancing material are in physical contact. In other embodiments, the contact-enhancing material makes contact with the exposed portions of the nanotubes lying in the plane of the upper surface but does not fill the nanotubes.

The method of FIG. 2 is also applicable to treatment of the nanotubes followed by incorporation of the nanotubes with a matrix material to form a nano-composite. For example, some arc-discharge processes result in accumulation of a number of nanotubes randomly distributed in a grouping. These nanotubes are treated and subsequently combined with a matrix material to form a nano-composite in one specific embodiment of the present invention.

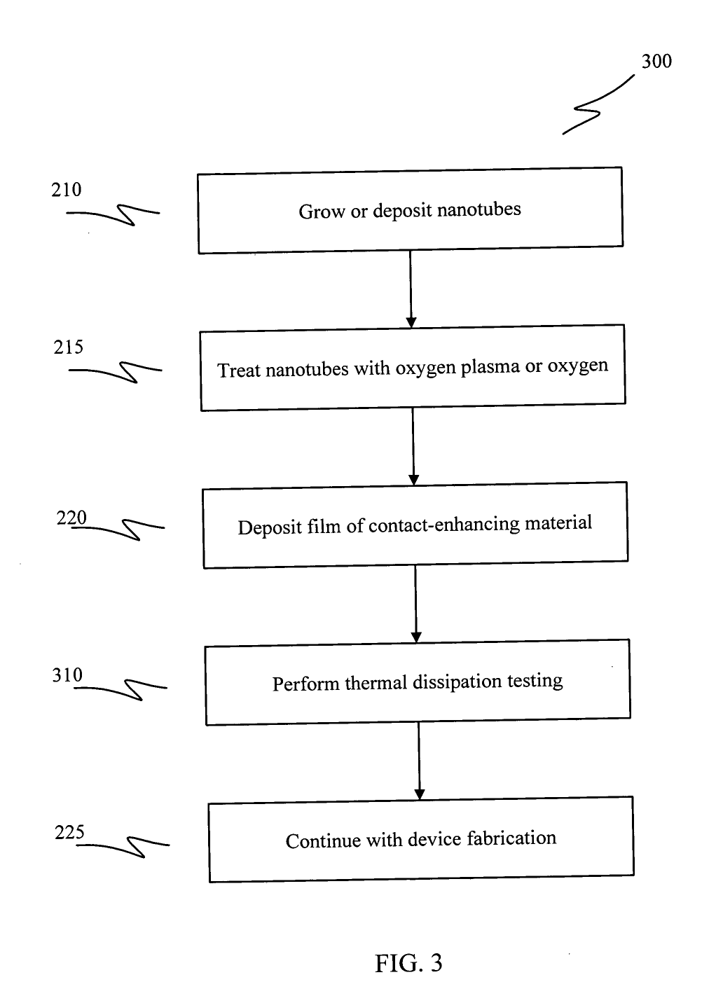

In an alternative embodiment, testing of thermal properties is performed as part of the treatment process. FIG. 3 is a flow diagram of an alternative process 300 for treating nanotubes to enhance thermal properties at the interface that can be employed during formation of laminate or other nano-composite materials. In the embodiment illustrated in FIG. 3, an additional step 310 is inserted between steps 220 and 225 of process 200 (FIG. 2). In step 310, thermal dissipation testing is performed after the film of contact-enhancing material is deposited (step 220) over the ends of the nanotubes in substantially uniform thermal contact with the nanotubes. Other thermal properties (e.g., thermal conductivity) could also be tested instead of or in addition to thermal dissipation.

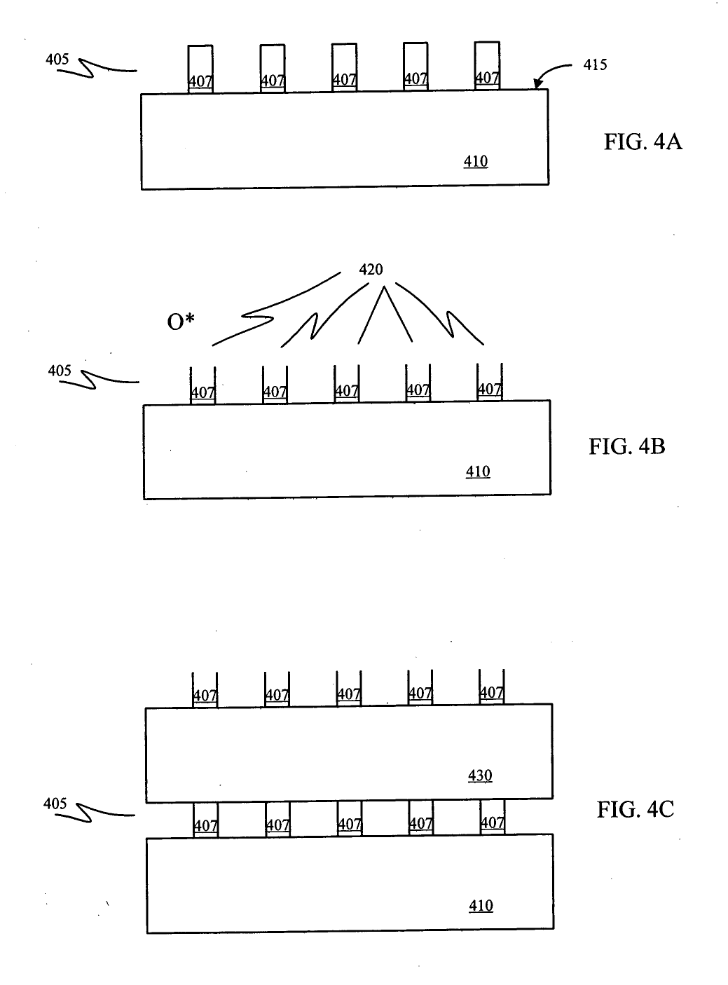

FIGS. 4A-4C are simplified cross-sectional schematic views of the fabrication of a laminate structure according to an embodiment of the present invention. In FIG. 4A (not to scale), a film-like layer 405 comprising aligned nanotubes 407 has been deposited on matrix material 410. As mentioned previously, at the matrix material-nanotube interface 415, the contact resistance will be reduced because the nanotubes are grown directly on the surface of the matrix material. In alternative embodiments, the nanotubes are formed on substrates not intended for use in a laminate structure, for example, nano-composite materials as described above. In these alternative embodiments, the growth of the nanotubes directly on the supporting surface will produce a similar reduction in contact resistance.

FIG. 4B illustrates the treatment of the “free” ends 420 of the nanotubes 407. An oxygen plasma, represented by the excited oxygen radical O*, is introduced in the vicinity of the laminate structure. The oxygen radicals interact with the nanotubes to convert carbon near the tips of the nanotubes to CO and/or CO₂. As a result, the ends of the nanotubes are opened as illustrated in FIG. 4B.

FIG. 4C illustrates several layers of the laminate structure after further assembly. As illustrated in FIG. 4C, the structure illustrated in FIG. 4B has been cut into sections that are stacked to produce the laminate structure illustrated in FIG. 4C. In this embodiment, the treatment of the ends of the nanotubes 407 has been used to decrease the thermal contact resistance between the top of layer 405 and the bottom of layer 430.

Although the laminate structure illustrated in FIGS. 4A-4C is described as being fabricated by cutting a processed structure into sections and stacking them, this is not required by the present invention. In alternative embodiments, a contact-enhancing material is deposited on the nanotube layer after treatment of the nanotubes. After deposition of this contact-enhancing material, the next layer of matrix material is deposited, continuing the fabrication of the laminate material. The next layer of matrix material may be the same as the contact-enhancing material or different. In other embodiments, the matrix material/nanotube/contact-enhancing material structure can be cut into sections and stacked as previously illustrated.

Moreover, although the treatment of nanotubes has been discussed in the context of a laminate nano-composite material, this is not required by the present invention. In some embodiments, the thermal contact system of the present invention will be useful to decrease the contact resistance between nanotubes and adjacent materials in other contexts, e.g., as described above.

As noted above, step 310 of process 300 (FIG. 3) involves thermal dissipation measurement. A suitable system for such measurements is described in detail in above-referenced co-pending application Ser. No. ______(Attorney Docket No. 022353-000310US).

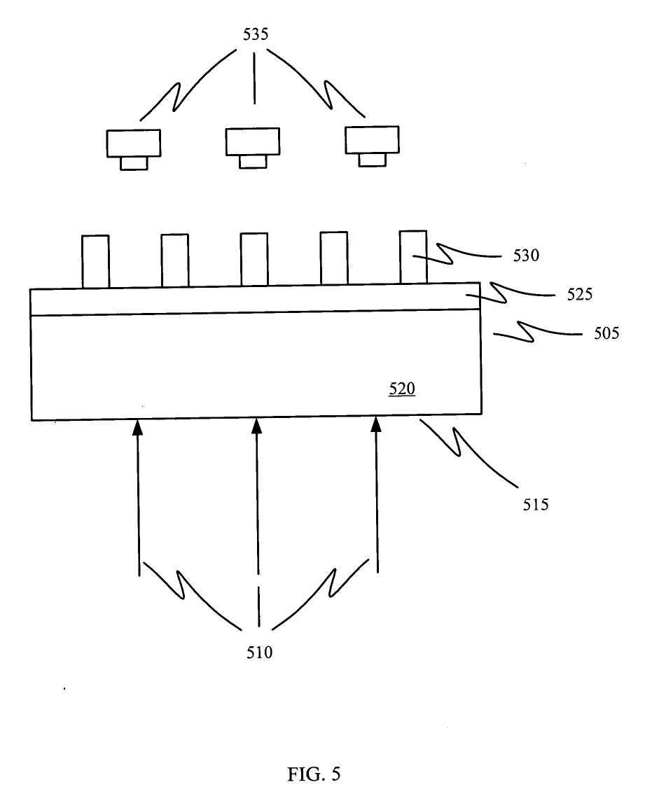

FIG. 5 is a schematic diagram of a thermal dissipation measurement system according to an embodiment of the present invention. As illustrated in FIG. 5, laser pulses 510 are incident on a lower surface 515 of the nano-engineered material 505. The wavelength of the laser radiation is selected to provide for absorption of the laser radiation by the lower surface 515 of the nano-engineered material. Merely by way of example, laser radiation in the ultraviolet, visible, or infrared spectrum may be utilized depending on the spectral absorption coefficients of the material used to fabricate the nano-engineered material.

The laser pulses may be incident on the material in a sequential or simultaneous manner, as desired by the operator. Of course, other radiation sources, including electron beams, could be utilized in place of the laser beams to provide a controllable source of incident radiation. In a specific embodiment, a single laser source is used with a moveable mirror to direct the laser pulses to predetermined locations on the sample. In this specific embodiment, laser pulses are directed to impinge on the material with a lateral spacing (x-axis) of about 1 cm and a longitudinal spacing (y-axis) of about 1 cm. Generally, the density of laser pulses is approximately equal to 1 pulse per square centimeter. The spacing between laser pulses can be larger for larger samples in a manufacturing environment or for optimizing manufacturing depending on the application. Of course, the distribution of the laser pulses need not be uniform. In this specific embodiment, the material is translated along the x and y-axes, providing for laser pulses impinging on the material in a two-dimensional pattern. In another embodiment, the laser source is translated. In alternative embodiments, multiple laser sources or optical beamsplitters are utilized to create simultaneous laser pulses incident on the material in either a linear arrangement of pulses or a two-dimensional arrangement of pulses.

In a particular embodiment, the wavelength and intensity of the laser pulses 210 is predetermined and matched to the absorption coefficient of the nano-engineered material to define a desired thermal profile. The intensity of the laser pulse can be increased by increasing the laser power or decreasing the spot size of the laser at the surface of the nano-engineered material. In this particular embodiment, the radiation will be absorbed in a small region surrounding the point where the pulse impinges on the lower surface of the nano-engineered material. In one embodiment, the laser spot size at the surface of the nano-engineered material ranges from 0.1 m-100 m. Absorption of the laser radiation will create a thermal gradient between the lower and upper surfaces of the material and result in dissipation of the absorbed energy through the upper surface of the material. Operation of the laser pulses in a simultaneous manner provides the operator with a means to establish initial thermal gradients that vary as a function of position. Merely by way of example, simultaneous laser pulses incident near the periphery of the material will establish a different thermal profile than a single laser pulse incident near the center of the material.

In the embodiment of the nano-engineered material 205 illustrated (not to scale) in FIG. 2, the material includes a substrate 220, a catalyst layer 225, and a plurality of nanotubes 230. Although a catalyst layer is included in the embodiment illustrated in FIG. 2, growth of nanotubes does not always require a catalyst and layer 225 is not required. In some embodiments. Heat dissipated through the upper surface of the material, including through the nanotubes 230, is detected by infrared cameras 235 positioned above the nano-engineered material. The spectral detectivity of the infrared cameras is selected to overlap the spectral signature of the thermal profiles present in the material. The lateral spacing between the cameras enables the operator to perform measurements of the uniformity of heat dissipation from the nano-engineered material using the measurement system illustrated in FIG. 2. Additionally, as discussed above, translation of the nano-engineered material with respect to the laser pulses and/or measurement cameras can be performed to verify uniformity data and characterize edge effects, among other properties. In a particular embodiment, the material is mounted on a moveable gantry that is controllable in at least two dimensions. During testing, the gantry translates the material with respect to the laser pulses and/or measurement cameras as the data on the primary property is collected.

It will be appreciated that process 200 and 300 are illustrative and that variations and modifications are possible. Steps described as sequential may be executed in parallel, order of steps may be varied, and steps may be modified or combined. A variety of materials may be used for enhancing thermal contact, including copper, silver, aluminum, indium, other metals, or alloys. The treating step may include exposure to a variety of other etchants or gases.

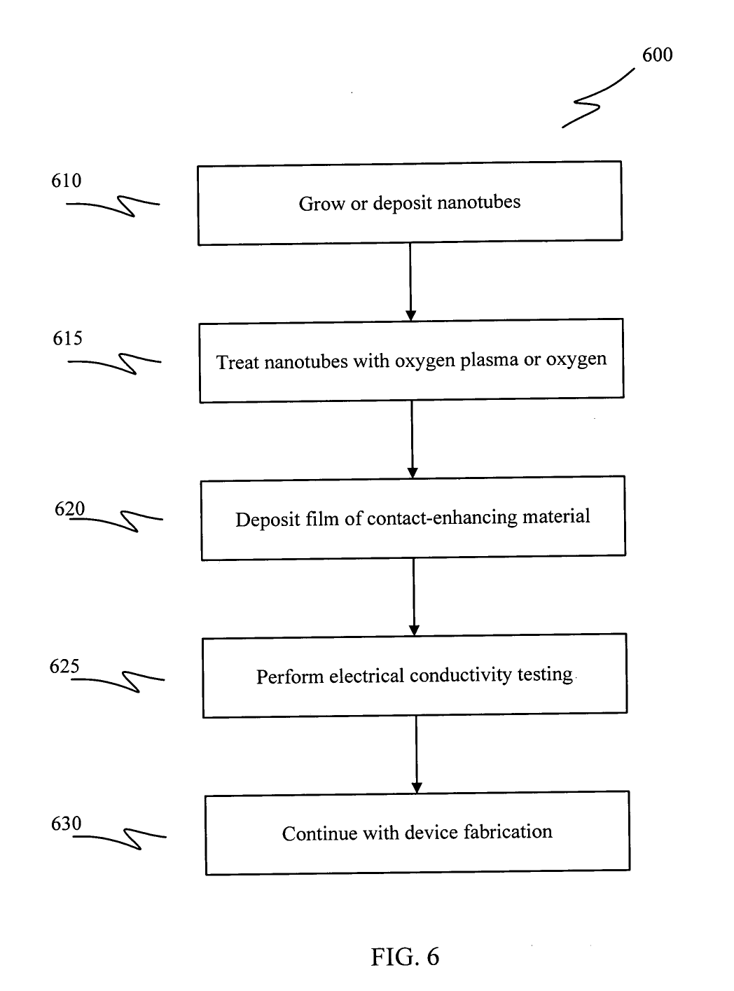

In yet another alternative embodiment, the material selected for use in depositing the film of contact-enhancing material is chosen with a view to enhancing electrical conductivity in addition to or instead of thermal conductivity. FIG. 6 is a flow diagram of an alternative process 600 for treating nanotubes to enhance electrical conductivity at the interface that can be employed during formation of laminate or other nano-composite materials.

At step 610, nanotubes are grown (e.g., using CVD or other conventional processes) or deposited onto a substrate or base material. After nanotube growth or deposition, a “treating” step 615 is performed to open the ends of the nanotubes and reduce variations in the lengths of the nanotubes. In one embodiment, treating the nanotubes includes exposing the nanotubes to an oxygen plasma or energetic oxygen at a suitable temperature (e.g., 700° C.) so that carbon near the tips is converted to CO and/or CO₂.

Once the nanotubes have been treated, a film of contact-enhancing material is deposited (step 620) over the ends of the nanotubes in substantially uniform electrical contact with the nanotubes. The contact-enhancing material is advantageously selected for high electrical conductivity; for example, gold, copper, silver, aluminum, indium, or other metals are used in specific embodiments.

At step 625, electrical conductivity testing is performed as part of the treatment process. As part of step 625, the uniformity of the electrical conductivity and the absolute values of electrical conductivity as a function of position are measured in some embodiments. Next, at step 630, device fabrication continues as appropriate. In some embodiments, the film deposited at step 620 is used as the next base material layer for a laminate structure as illustrated in FIG. 1A. In these embodiments, the next steps generally involve depositing or growing another film of nanotubes. In other embodiments, further deposition of base material may be performed prior to further nanotube growth.

Thus, although the invention has been described with respect to specific embodiments, it will be appreciated that the invention is intended to cover all modifications and equivalents within the scope of the following Claims.

1. A method for enhancing contact between a nanotube and a first material, the method comprising:
providing a nanotube, said nanotube having ends; and
treating at least one of said ends of said nanotube.

2. The method of claim 1, wherein said contact is thermal contact.

3. The method of claim 1, wherein said contact is electrical contact.

4. The method of claim 1, wherein said treating step includes exposing said nanotube to an oxygen plasma.

5. The method of claim 1, wherein said treating step includes exposing said nanotube to energetic oxygen.

6. The method of claim 1, wherein said treating step includes opening at least one of said ends of said nanotube.

7. The method of claim 1, wherein said first material is another nanotube.

8. The method of claim 1, wherein said first material is selected from the group consisting of metal, plastic, and ceramic.

9. The method of claim 8, wherein said nanotube and said first material form a composite material.

10. The method of claim 1, further comprising:
depositing a contact-enhancing material in physical contact with at least one end of said nanotube, wherein said contact-enhancing material is selected based on thermal conductivity.

11. The method of claim 10, wherein said contact-enhancing material is selected from the group consisting of copper, silver, aluminum, indium, and diamond.

12. The method of claim 10, wherein said contact-enhancing material has an electrical conductivity greater than that of said first material.

13. The method of claim 1, wherein said nanotube is formed on a substrate.

14. The method of claim 13, wherein said forming step includes forming said nanotube such that an axis of said nanotube is generally aligned to a selected direction.

15. The method of claim 10, wherein said first material and said contact-enhancing material are substantially identical in composition.

16. A nano-engineered material, comprising:
a base material;
a nanostructure coupled to said base material, wherein said nanostructure is treated to enhance thermal contact; and
a contact-enhancing material coupled to said nanostructure.

17. The nano-engineered material of claim 16, wherein said treatment of said nanostructure includes exposing said nanostructure to an oxygen plasma.

18. The nano-engineered material of claim 16, wherein said treatment of said nanostructure includes exposing said nanostructure to energetic oxygen.

19. The nano-engineered material of claim 16, wherein said treatment of said nanostructure includes opening a portion of said nanostructure.

20. The nano-engineered material of claim 19, wherein said nanostructure is a nanotube.

21. The nano-engineered material of claim 19, wherein said contact-enhancing material fills said nanostructure.

22. The nano-engineered material of claim 16, wherein said contact-enhancing material is selected based on thermal conductivity.

23. The nano-engineered material of claim 16, wherein said contact-enhancing material is selected from the group consisting of copper, silver, aluminum, indium, and diamond.

24. The nano-engineered material of claim 16, wherein said contact-enhancing material is selected based on electrical conductivity.

25. The nano-engineered material of claim 16, wherein said base material and said contact-enhancing material are substantially identical in composition.

26. A nano-composite material, comprising:
a matrix material;
a nanostructure incorporated into said matrix material, wherein said nanostructure is treated to enhance thermal contact.

27. The nano-composite material of claim 26, wherein said nanostructure is thermally coupled to said matrix material.

28. The nano-composite material of claim 27 wherein said nanostructure is embedded in said matrix material.
